(19) United States
(12) Patent Application Publication
(10) Pub. No.: US 2010/0082435 A1
(43) Pub. Date: Apr. 1, 2010

(54) CUSTOMIZABLE AD MARKER

(75) Inventor: Steven Hartman, Hermosa Beach, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/240,653

(22) Filed: Sep. 29, 2008

(51) Int. Cl. G06Q 30/00

(52) U.S. Cl. 705/14.55

(57) ABSTRACT

The present invention is directed towards systems and methods for publisher customization of advertisement data. The method according to one embodiment of the present invention comprises requesting an advertisement in response to a request for a webpage. The method then determines if an ad marker exists for the requested advertisement and returns a custom ad marker, if said ad marker exists, or returns a generic ad marker if said custom ad marker does not exist.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to publisher customization of advertisement data. More specifically, embodiments of the present invention are directed towards systems and methods for allowing a publisher to update dynamically generated ad marker data.

### BACKGROUND OF THE INVENTION

Since the widespread adoption of the Internet, online advertising has proven to be an important and lucrative form of advertising. Internet advertising has quickly rivaled traditional forms of print, radio and television advertisements as a cost-effective method of advertisement delivery, earning substantial profits with minimal overhead per advertisement delivered. During the infancy of online advertising, advertisers modeled their advertisements closely on the traditional forms of print advertising. Advertisements were generally limited to banner or billboard images displayed on the tops or sides of webpages.

As online revenues grew, many began to turn more attention towards online advertising as a viable form of advertising. Consequently, many advancements were made with respect to the presentation of advertisements and market analysis thereof. Advertisers could more accurately target their advertisements than ever before higher bandwidths combined with advancing technologies allowed advertisers to utilize new mode of advertising, e.g., video advertisements and interactive advertisements, further increasing advertiser revenue.

However, remnants of the early stages of online advertisements still remain present to this day. Many advertisements, such as banner advertisements, still rely solely on stock text, or “ad markers,” to identify their content as advertisements. Many times this stock text is merely a non-descriptive caption such as the text “ADVERTISEMENT”. The use of this stock text does not fully exploit the valuable screen space available to publishers and advertisers and many times collides with the artistic vision a publisher of or advertiser wishes to convey.

Thus there is a need in the art for system and methods for allowing publishers to create or modify ad markers, as well as provide ad markers that are dynamic pieces of an advertisement.

### SUMMARY OF THE INVENTION

Embodiments of the present invention are directed towards systems methods and computer program products for managing advertisement request data. The method of the present invention comprises receiving a request for a webpage and requesting an advertisement in response to the request for a webpage. In one embodiment, requesting an advertisement further comprises executing an advertisement query on a corpus of advertisements; wherein the query comprises contextual search terms on other query data.

The method determines if an ad marker exists for the requested advertisement. In one embodiment, an ad marker comprises custom textual, graphical or functional data, which may comprise commands or instructions, as well as one or more hyperlinks. In a first embodiment, graphical data comprises text color or background color of the ad marker. In an alternative embodiment, an ad marker further comprises control values dictating the performance of a given ad marker.

The method returns a custom ad marker, if a custom ad marker exists or returns a generic ad marker if the custom ad marker does not exist. In an alternative embodiment, the method may further allow a publisher to update or create the custom ad marker. Additionally, the method may provide a modification or creation application (which may be run by or at a client device) for updating or creating the ad marker.

A system according to one embodiment of the present invention comprises a plurality of publishers coupled to a network operative to receive requests for webpages, as well as transmit webpages, and a plurality of client devices coupled to a network operative to request an advertisement in conjunction with the webpage. In one embodiment, the publisher is operative to update or create the custom ad marker. Additionally, the content server may be operative to display a modification or creation form for updating or creating the custom ad marker. The system further comprises a content server operative to receive requests for advertisements and retrieve at least one advertisement. In one embodiment, the content server is operative to execute an advertisement query on a corpus of advertisements when retrieving an advertisement. Additionally, an advertisement query may comprise contextual search terms.

The system further comprises an ad controller operative to: determine if an ad marker exists for the retrieved advertisement. If an ad marker exists, the ad controller returns a custom ad marker. If no ad marker exists, the ad controller returns a generic ad marker. In one embodiment, an ad marker comprises custom textual, graphical or functional data. In a first embodiment, functional data may comprise commands or instructions, as well as at least one hyperlink. In a second embodiment, graphical data comprises text color or background color of the ad marker. In a third embodiment, an ad marker further comprises control values.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for allowing an publisher to manage ad marker data according to one embodiment of the present invention;

FIG. 2 presents a flow diagram illustrating a method for retrieving a custom ad marker according to one embodiment of the present invention; and

FIG. 3 presents a flow diagram illustrating a method for creating or updating a custom ad marker according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

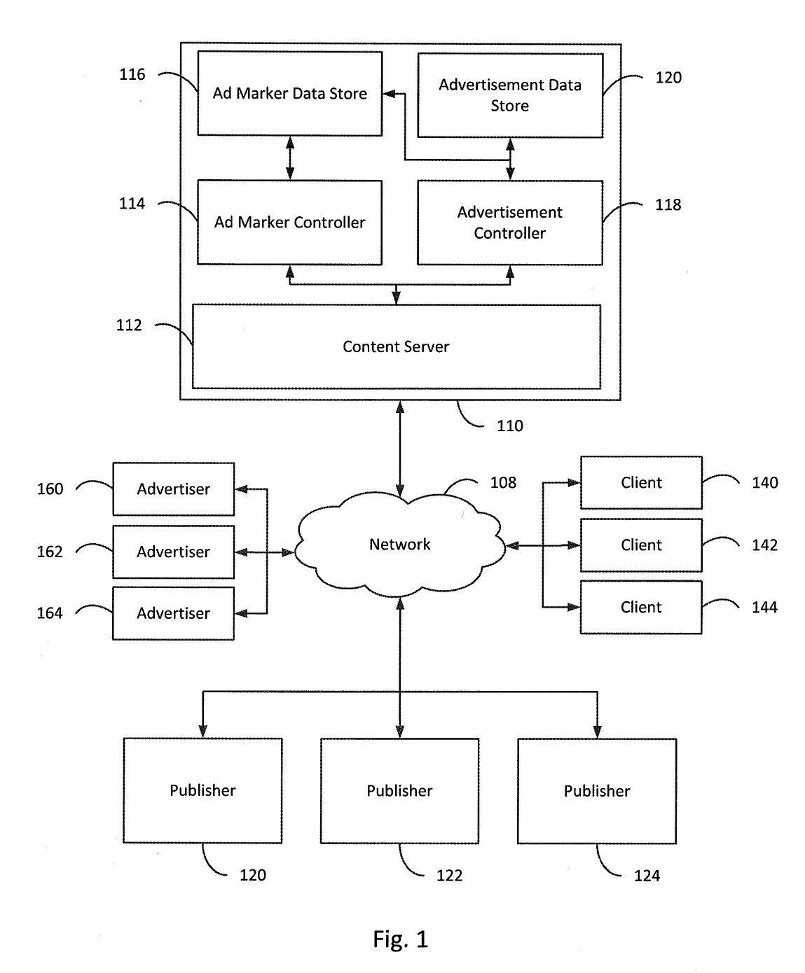

FIG. 1 presents a block diagram depicting a system for allowing a publisher to manage custom ad marker data according to one embodiment of the present invention. According to the embodiment that FIG. 1 illustrates, one or more publishers 120, 122, 124, client devices 140, 142, 144 and advertisers 160, 162, 164 are coupled to a network 118. For example, a wide area network such as the Internet. Publishers 120, 122, 124, client devices 140, 142, 144 and advertisers 160, 162, 164 may be operative to communicate with an advertisement provider 110 via a network 108. In the present embodiment, advertisement provider 110 may comprise a content server 112 (e.g., Apache™, Internet Information Server™, etc.), ad marker controller 114, ad marker data store 116, advertisement controller 112 and advertisement data store 120. Publishers 120, 122, 124, client devices 140, 142, 144 and advertisers 160, 162, 164 may comprise general purpose computing devices having a central processing unit, memory unit, permanent storage, optical drive(s), universal serial bus port(s), audio/video output devices, network interfaces, etc.

A client device 140, 142, 144 may comprise a computing device operative to retrieve and display content items in response to user input, such as entering a uniform resource locator (“URL”) into a location bar of a web browser or selecting a hyperlink containing a URL. Content items may be webpages associated with a website administered by a publisher 120, 122, 124 as is known in the art. In response to displaying a webpage, a client device 140, 142, 144 may be operative to request advertisement content from advertisement provider 110 via network 108. In one embodiment, a request for advertisements may comprise an automatic request triggered by a webpage provided by a given publisher 120, 122, 124. For example, a content item that a publisher 120, 122, 124 provides may comprise code instructing a client device 140, 142, 144 to retrieve advertisements from advertisement provider 110.

In the present embodiment, a publisher 120, 122, 124 comprises a computing device operative to serve webpages to an end user such as a client device 140, 142, 144. Additionally, a publisher 120, 122, 124 may further be operative to communicate with advertisement provider 110 to perform ad marker maintenance, as is described in greater detail herein. An advertiser 106 may comprise a computing device operative to transmit advertising data to advertisement provider 110. In one embodiment, advertiser 108 may be operative to transmit advertisement data containing a graphical, textual, audio or video advertisement for storage by advertisement provider 110. Alternatively, or in conjunction with the forgoing, advertiser 160, 162, 164 may transmit advertisement-identifying indicia operative to provide location data for audio, graphical, or video advertisements, such as a URL.

In the present embodiment, advertisement provider 110 comprises a content server 112 operative to receive requests from publishers 120, 122, 124, clients 140, 142, 144 or advertisers 160, 162, 164. Content server 112 is coupled to ad marker controller 114 and transmits requests from publishers to the ad marker controller 114. In alternative embodiments, advertisement provider 110 may comprise various other controller modules operative to handle ancillary aspects of handling requests such as authentication modules.

Ad marker controller 114 allows a given publisher to create or update ad markers stored within the ad marker data store 116. In one embodiment, ad marker controller 114 is operative to provide an administrative panel to allow viewing or updating of ad markers associated with a given publisher. Ad marker controller 114 may be operative to dynamically generate an administrative panel for modification or creation of ad markers and may forward data representing the panel to content server 112. Content server 112 is operative to transmit administrative panel data to a plurality of publishers 120, 122, 124.

Ad marker data store 116 comprises one or more data storage modules operative to store ad maker parameters related to ad markers including, but not limited to, textual, graphical, stylistic or functional aspects of the ad marker. In one embodiment, functional aspects of an ad marker correspond to URLs associated with the ad marker. Additionally, ad marker parameters may comprise various “flags” or control values dictating the performance of a given ad marker. For example, a publisher may set a behavior targeting flag indicating whether the publisher wishes to opt out or in of behavioral targeting or an enabled flag indicating whether the ad marker is to be retrieved or ignored. Ad marker parameters may be utilized to generate a visual indicator rendered near or around an advertisement to allow differentiation from a publisher's content. In one embodiment, ad marker data store 116 comprises one or more relational databases containing a plurality records associated with each ad marker. In alternative embodiments, ad marker data store may comprise flat files or any storage mechanism known in the art.

Content server 112 is additionally coupled to advertisement controller 118. In the present embodiment, advertisement controller 118 is operative to handle requests for advertisements and associated ad markers received from content server 112. Content server 112 may be operative to extract information related to the identification of advertisements from HTTP requests received from the client devices. For example, content server 112 may receive a query string with multiple parameters with at least one parameter containing the identification of an advertisement for retrieval. Alternatively, content server 112 (or other components of the advertisement provider 110) may receive various other pieces of information (e.g., client profile data, location data, historical data, etc.) and may dynamically determine the identification of advertisement. In another embodiment, content server 112 may transmit an “advertisement query” to advertisement controller 118. An advertisement query may comprise a plurality of search parameters useful in identifying a relevant advertisement.

Advertisement controller 118 retrieves advertisements from advertisement data store 120 and, if present, an associated ad marker data from ad marker data store 116. In one embodiment, advertisement controller 118 identifies advertisements and ad markers via an advertisement identification code or identifier. In alternative embodiments, advertisement controller 118 retrieves multiple advertisements and ad markers by executing a query on both data stores 116, 120. Advertisement controller 118 may be further operative to analyze the data within ad marker data store 116 to determine various display parameters for the ad marker. For example, advertisement controller 118 may format an ad marker according to various stored parameters.

Formatting an ad marker may comprise generating HTML markup on the basis of formatting parameters stored within ad marker data store 116. In addition to stylistic formatting, advertisement controller 118 may dynamically create hyperlinks associated with the ad marker on the basis of data stored within the ad marker data store 116. Alternatively, or in conjunction with the foregoing, advertisement controller 118 may be operative to generate hyperlinks on the basis of contextual parameters such as time, history or search queries executed by the client. Advertisement controller 118 may format the advertisement and ad marker, transmitting the formatted advertisement and ad marker to content server 112. In response, content server 112 transmits the advertisement and ad marker to the requesting client device 140, 142 or 144.

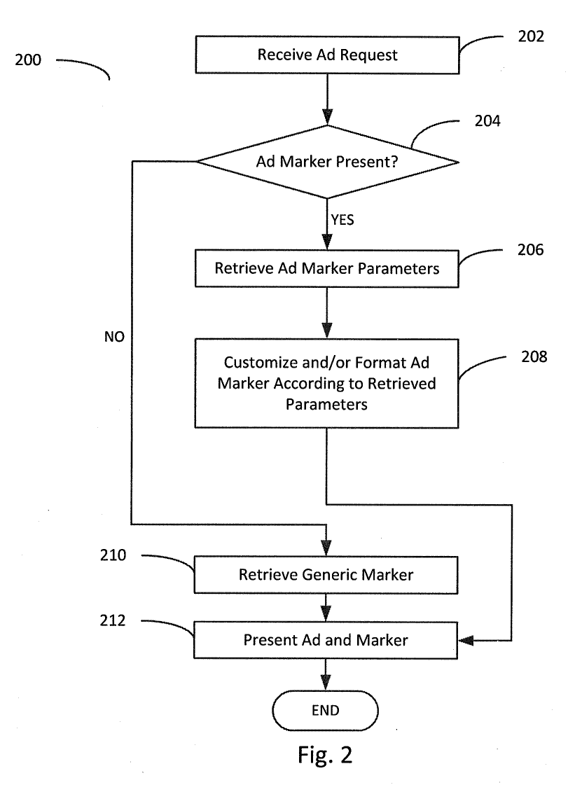

FIG. 2 presents a flow diagram illustrating a method for retrieving a custom ad marker according to one embodiment of the present invention. According to the embodiment that FIG. 2 illustrates, the method 200 receives an ad request, step 202, which, in one embodiment, comprises receiving an HTTP request from a client device. For example, a client device may submit an HTTP request to an advertisement provider when processing a publisher webpage through use of the “src” attribute present in various HTML tags such as the “img” or “iframe” tags.

The method 200 determines if an ad marker exists for the requested advertisement, step 204. Determining if an ad marker exists according to one embodiment comprises querying a database or similar structure to determine if ad marker data is available for the requested advertisement. If the method 200 determines that ad marker data does not exist for the identified advertisement, the method 200 retrieves generic ad marker data, step 210. In one embodiment, generic ad marker data comprises stock text or hyperlinks applicable to the type of ad requested. For example, a banner advertisement may have a generic ad mark of text containing the word “ADVERTISEMENT” and a hyperlink to the advertiser's home page.

If the method 200 determines that a custom ad marker is present, the method retrieves the ad marker parameters, step 206. In the present embodiment, the method 200 retrieves ad marker parameters from a database or similar data store. As previously mentioned, ad marker parameters may comprise textual, graphical, stylistic or functional parameters. The method 200 may customize and format the ad marker according to the ad marker parameters, step 208. In one embodiment, customizing and formatting an ad marker according to ad marker parameters comprises modifying a generic ad marker, or “shell” marker, according to the retrieved parameters. For example, a shell marker may contain the structural constraints of the ad marker (e.g., size, required text, etc.) and may initially contain shell data (e.g., the text “ADVERTISEMENT” or a pre-defined color scheme). Customizing and formatting a shell marker may comprise replacing the shell data with the retrieved parameters while maintaining the structural constraints.

The method 200 then presents the advertisement and customized or generic marker, step 212. Presenting an advertisement and ad marker comprises transmitting the advertisement and ad marker to a client device, wherein the client device renders the advertisement onto a display device. For example, the method 200 may transmit the advertisement and ad marker to a client device executing a web browser, wherein the web browser renders the advertisement at a location within the webpage.

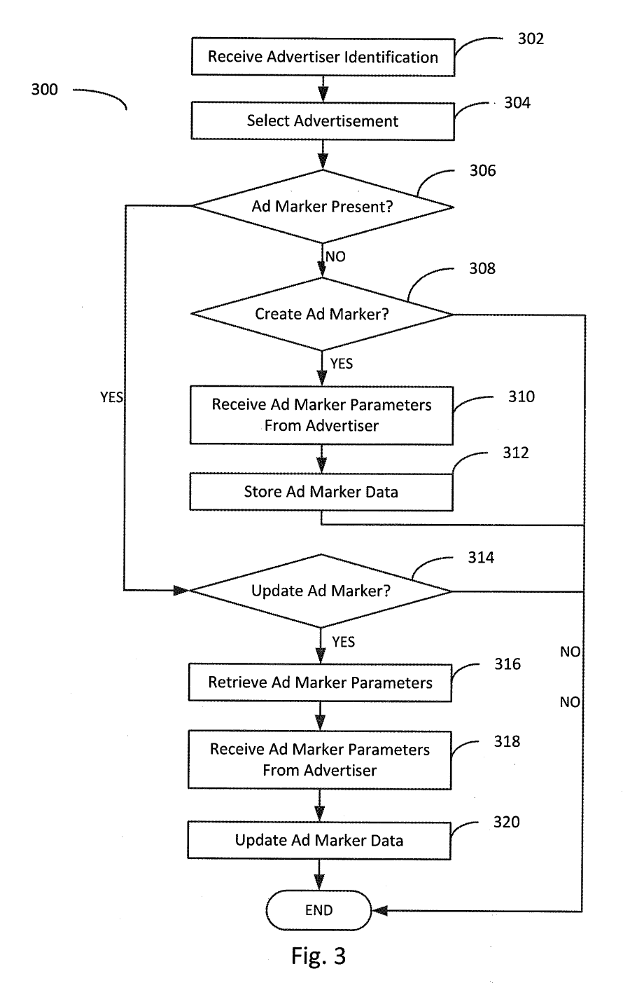

FIG. 3 presents a flow diagram illustrating a method for creating or updating a custom ad marker according to one embodiment of the present invention. As the embodiment in FIG. 3 illustrates, the method 300 receives publisher identification, step 302, which may comprise receiving authenticating data such as a username/password combination, digital certificate, token identification or any other authentication mechanisms known in the art.

The method 300 may select an advertisement, step 304. In one embodiment, selecting an advertisement is performed in response to a selection made by a publisher. For example, in response to receiving publisher identification, the method 300 displays one or more advertisements associated with a publisher wherein a publisher may select a given advertisement for modification. In an alternative embodiment, the method 300 may simply display an ad marker used for advertisements associated with a publisher (e.g., a “site-wide” ad marker). The method 300 may determine if an ad marker is present for a given advertisement, step 306. In one embodiment, determining if an ad marker is present comprises querying an ad marker database for the presence of ad marker database.

If an ad marker is not present, step 306, the method 300 determines if the publisher wishes to create a custom ad marker for the selected advertisement, step 308. In one embodiment, determining if a publisher wishes to create a custom marker comprises providing a graphical user interface allowing the publisher to select an option to create an ad marker. If a publisher does not choose to create a custom ad marker, step 308, the method 300 ends. If the publisher selects to create a custom ad marker the method 300 receives custom ad marker parameters from the publisher, step 310, and stores the custom ad marker parameters, step 312.

In the present embodiment, receiving ad marker parameters comprises receiving user input via a web application through the use of HTTP requests, e.g., through the use of POST headers. In one embodiment, the method 300 is operative to provide a graphical interface allowing the publisher to interactively create an ad marker. For example, the method 300 may provide a form allowing user input for a plurality of parameters associated with an ad marker such as text color, background color, hyperlinks and various flags. Alternatively, the method 300 may provide a graphical display of the ad marker and may allow a publisher to modify the marker in a “what you see is what you get” (WYSIWYG) environment. After the publisher is finished modifying the ad marker, the publisher may submit the parameters via a submit button or similar mechanism, allowing the transfer of data via the HTTP protocol, as known in the art.

If the method 300 detects an ad marker in step 306, the method 300 determines if the publisher wishes to update an existing ad marker, step 314. If the publisher does not wish to update an existing marker, the method 300 ends. If the publisher decides to update an existing ad marker, step 314, the method 300 retrieves the ad marker parameters, step 316. In one embodiment, retrieving ad marker parameters comprises accessing a database of ad markers. In the present embodiment, the method 300 displays the ad marker parameters the publisher requests. In one embodiment, the method 300 displays ad marker parameters by displaying a form or similar mechanism populated with the existing data; allowing the user to replace, update or remove data. In an alternative embodiment, the method 300 displays a graphical rendering of the ad marker and allows the publisher to replace, update or remove data in a WYSIWYG environment.

When the publisher finishes editing the ad marker, the method 300 may receive the ad marker parameters, step 318. In one embodiment, receiving ad marker parameters comprises receiving data via an HTTP request from the publisher. The method 300 then updates the ad marker parameters, step 320. In the present embodiment, the method 300 accesses a database containing the original ad marker, updating and storing the parameters the publisher provides.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for publisher customization of advertisement data, the method comprising:
requesting an advertisement in response to a request for a webpage;
determining if an ad marker exists for the advertisement;
returning a custom ad marker, if said ad marker exists; and
returning a generic ad marker if said custom ad marker does not exist.

2. The method of claim 1 wherein returning a custom ad marker comprises retrieving custom textual, graphical or functional data associated with an ad marker.

3. The method of claim 2 wherein retrieving functional data comprises at retrieving least one hyperlink.

4. The method of claim 2 wherein retrieving graphical data comprises retrieving one of text color or background color of the ad marker.

5. The method of claim 2 wherein returning a custom ad marker comprises retrieving at least one control value.

6. The method of claim 1, comprising allowing a publisher to update or create said custom ad marker.

7. The method of claim 6, comprising providing a modification or creation application for the updating or creation of the ad marker.

8. The method of claim 1 wherein requesting an advertisement comprises executing an advertisement query on a corpus of advertisements.

9. The method of claim 8 wherein executing an advertisement query comprises executing a query comprising contextual search terms.

10. A system for publisher customization of advertisement data, the system comprising:
a plurality of publishers coupled to a network operative to receive requests for webpages and transmit webpages;
a plurality of client devices coupled to a network operative to request an advertisement in response to the transmittal of a webpage;
a content server operative to receive requests for advertisements and retrieve at least one advertisement; and
an ad controller operative to:
determine if an ad marker exists for the retrieved advertisement;
returning a custom ad marker, if said ad marker exists; and
returning a generic ad marker if said custom ad marker does not exist.

11. The system of claim 10 wherein an ad marker comprises custom textual, graphical or functional data.

12. The system of claim 11 wherein said functional data comprises at least one hyperlink.

13. The system of claim 11 wherein graphical data comprises text color or background color of the ad marker.

14. The system of claim 11 wherein an ad marker further comprises control values.

15. The system of claim 10 wherein said publisher is operative to update or create said custom ad marker.

16. The system of claim 15 wherein said content server is operative to display a modification or creation form for the updating or creation of the ad marker.

17. The system of claim 10 wherein the content server is operative to execute an advertisement query on a corpus of advertisements when retrieving at least one advertisement.

18. The system of claim 17 wherein said query comprises contextual search terms.

19. Computer readable media comprising program code that when executed by a programmable processor causes the programmable processor to execute a method for publisher customization of advertisement data, the computer readable media comprising:
program code for requesting an advertisement in response to a request for a webpage;
program code for determining if an ad marker exists for the advertisement;
program code for returning a custom ad marker, if said ad marker exists; and
program code for returning a generic ad marker if said custom ad marker does not exist.

20. The computer readable media of claim 19 wherein program code for returning a custom ad marker comprises program code for retrieving custom textual, graphical or functional data associated with an ad marker.

21. The computer readable media of claim 20 wherein program code for retrieving functional data comprises program code for retrieving at least one hyperlink.

22. The computer readable media of claim 20 wherein program code for retrieving graphical data comprises program code for retrieving one of text color or background color of the ad marker.

23. The computer readable media of claim 20 wherein program code for returning a custom ad marker comprises program code for retrieving at least one control value.

24. The computer readable media of claim 19 further comprising program code for providing a modification or creation application for the updating or creation of the ad marker.

25. The computer readable media of claim 19 wherein program code for requesting an advertisement further comprises program code for executing an advertisement query on a corpus of advertisements.

26. The computer readable media of claim 25 wherein program code for executing an advertisement query comprises program code for executing a query comprising contextual search terms.
